(19) United States
(12) Patent Application Publication
(10) Pub. No.: US 2021/0129617 A1
(43) Pub. Date: May 6, 2021

(54) SYSTEMS AND METHODS FOR MULTI-AXIALLY FORCE/TORQUE CONTROLLED ROTATING LEG ASSEMBLIES FOR A VEHICLE DRIVE AND SUSPENSION

(71) Applicant: The Florida State University Research Foundation, Inc., Tallahassee, FL (US)

(72) Inventors: Christian Hubicki, Tallahassee, FL (US); Jonathan Clark, Tallahassee, FL (US); Camilo Ordonez Ruiz, Tallahassee, FL (US)

(21) Appl. No.: 17/084,304

(22) Filed: Oct. 29, 2020

Related U.S. Application Data
(60) Provisional application No. 62/928,006, filed on Oct. 30, 2019.

(51) Int. Cl. B60G 17/06; B62D 21/11; B60G 7/00; B62D 57/02; B60G 17/0165

(52) U.S. Cl. CPC B60G 17/06; B62D 21/11; B60G 17/0165; B62D 57/022; B60G 7/00

(57) ABSTRACT

Multi-axially force/torque controlled rotating leg assemblies for a vehicle drive and suspension are disclosed herein. In some instances, the assemblies may include a chassis, a first hub rotatably attached to the chassis, and a first rotary actuator mechanically connected to the first hub. The first rotary actuator is configured rotate the first hub. The assemblies also may include a plurality of first rods moveably attached to the first hub and a plurality of first linear actuators. Each first rod of the plurality of first rods comprises a first linear actuator of the plurality of first linear actuators mechanically connected thereto. The first linear actuator is configured to extend and retract the first rod.

### CROSS-REFERENCE TO RELATED APPLICATIONS

The application claims priority to and the benefit of U.S. provisional patent application No. 62/928,006, filed Oct. 30, 2019, which is hereby incorporated by reference herein in its entirety.

### FIELD OF THE INVENTION

The invention generally relates to vehicles, and more particularly to multi-axially force/torque controlled rotating leg assemblies for a vehicle drive and suspension.

### BACKGROUND

As depicted in FIGS. 1A and 1B, combined wheel-leg vehicles include passive mechanical legs which act like passive suspensions. These devices are limited in how smooth a ride they can deliver, which limits their safe top speed. These devices also lack axial control of force. Although existing actuated spoked wheel designs can drive over uneven terrain, they can only do so slowly and lack force control capability. Adaptive suspensions with force control are highly geared, as depicted in FIGS. 1A and 1C, which slows response time for high-speed impacts. Legged robots with force control do not fully rotate their legs, so leg recirculation is inherently slow. Example existing technologies include Rimless wheel devices, RHex, IHMC OutRunner, MIT Cheetah 3, IMPASS (Hong), Recongurable Wheel-Track (CMU NREC), Multi-mode Extreme Travel Suspension (Pratt & Miller), and Handle (Boston Dynamics).

### BRIEF SUMMARY

New drive and suspension devices and vehicles are provided, along with methods for operating these devices and vehicles. In one aspect, the device includes (i) a chassis; (ii) a first hub rotatably attached to the chassis; (iii) a first rotary actuator mechanically connected to the first hub, wherein the first rotary actuator is configured rotate the first hub; (iv) a plurality of first rods moveably attached to the first hub; and (v) a plurality of first linear actuators, wherein each first rod of the plurality of first rods includes a first linear actuator of the plurality of first linear actuators mechanically connected thereto, and wherein the first linear actuator is configured to extend and retract the first rod.

In another aspect, a method is provided which includes (i) controlling a torque of a hub of a vehicle; and (ii) controlling a force and length of at least one rod of a plurality of rods extending from the hub, wherein each of the plurality of rods are configured to extend and retract from the hub.

In another aspect, a vehicle is provided which includes (i) a first rotatable hub having a plurality of first rods moveably attached thereto; (ii) a plurality of first linear actuators configured to extend and retract the plurality of first rods; (iii) a second rotatable hub having a plurality of second rods moveably attached thereto; and (iv) a plurality of second linear actuators configured to extend and retract the plurality of second rods.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A depicts a conventional passive wheel suspension.

FIG. 1B depicts a conventional passive rotating legs suspension.

FIG. 1C depicts a conventional active wheel suspension.

FIG. 2A depicts a high-speed rough terrain drive system according to one or more embodiments of the present disclosure.

FIG. 2B and 2C depict torque controlled wheel rotation and with a number of force controlled variable radius rods/spokes/legs according to one or more embodiments of the present disclosure.

FIGS. 3A-3C depict control schemes for a force/torque controlled wheel-leg drive according to one or more embodiments of the present disclosure.

FIG. 4A depicts a continuously variable transmission (CVT) behavior according to one or more embodiments of the present disclosure.

FIG. 4B depicts a dynamic maneuver for extreme obstacles according to one or more embodiments of the disclosure.

FIG. 5A depicts a drop off at safe location according to one or more embodiments of the present disclosure.

FIG. 5B depicts a quiet drive to evacuee at running pace and crouches for easy loading according to one or more embodiments of the present disclosure.

FIG. 5C depicts smooth, expedited transport back to for medevac evacuation site over rough terrain according to one or more embodiments of the present disclosure.

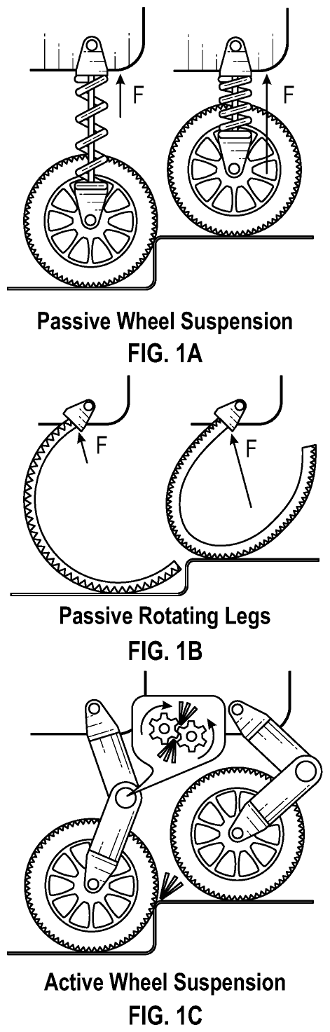

### DETAILED DESCRIPTION

New drive and suspension devices and ground- and/or water-based vehicles have been developed.

### Introduction

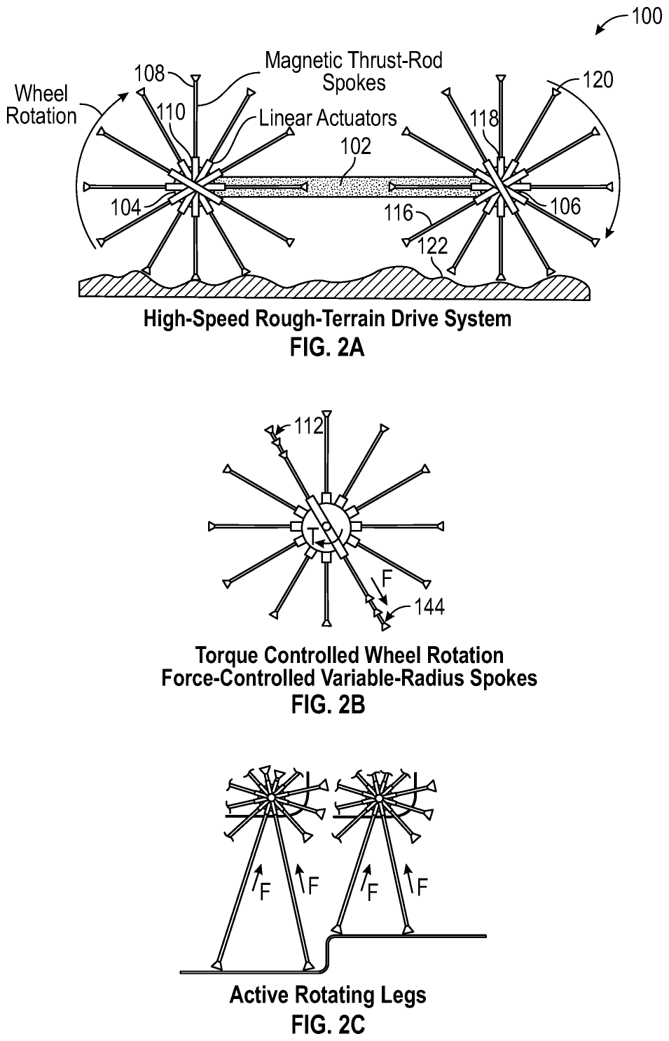

In certain embodiments, as depicted in FIG. 2A, a drive and suspension system is disclosed that is configured to drive ground vehicles at high speeds with minimum jerk over very rough and uncertain terrain. In some instances, an actuated wheel rotates an arrangement of actuated leg-like contact linkages (or spokes/rods) where both the wheel and each leg mechanism are force/torque controllable at high speeds, as depicted in FIGS. 2B and 2C. This multi-axial force/torque controllability enables a smooth ride for a mounted vehicle chassis, even over unseen rough terrain and at high vehicle speeds. In effect, a rider on a force-torque controlled vehicle disclosed herein can be made to feel as though they are floating on air, even as the vehicle clamors over rocky ground underneath. Applications of such a device include high-speed military vehicles, all-terrain emergency vehicles, medical patient transport, package delivery, and/or interplanetary exploration, among others.

In this manner, the drive and suspension system and associated methods disclosed herein provide the unique combination of multi-axis force/torque controllability with fast force/torque-response time on a 360 degree rotating wheel-leg assembly. The fully rotating active legs can control force even in the presence of high-speed impacts.

“Force/torque-controllability,” in this context, refers to the ability to measure, command, and accurately regulate “end-effector” forces and torques (i.e. at the point of contact with the world/terrain). A torque-controllable actuator drives the wheel through its central axis, which can both propel a vehicle and assist in balance control. Wheel-mounted force-controllable actuators extend to the ground and make contact with the terrain, controlling the effective “wheel” radius on-the-fly. These extending actuators primarily lift the vehicle and act as a suspension.

“Fast response” means that transient high-force spikes from sudden impacts at high speeds (e.g. hitting a bump or pothole) are translated by the force/torque controlled actuators into specific nonimpact forces dictated by software (e.g. smoothest possible ride). Two main technologies currently exist for fast-response force/torque controlled actuators: (A) minimally-geared force-transparent electromagnetic actuators and (B) force-instrumented hydraulic actuators.

In the device disclosed herein, the legs spin a full 360 degrees (in either direction) about the wheel axis. The connected force controlled actuators spin with the forward/backward wheel motion, allowing for a new ground contact point with each rotation. The 360 degree spin allows for new contact points without reversing rotation direction, and therefore drive faster than otherwise possible.

The fully rotating active legs can control force even in the presence of high speed impacts. As depicted in FIG. 2A, the drive and suspension system can drive fast with a highly smooth ride because the wheel-leg mechanism allows fast-response force/torque-control. Unlike a passive suspension or passive wheeled leg, this controlled device turns unexpected impact forces into smooth commanded forces, which minimizes damaging and speed limited vehicle jerks. In addition, unlike existing adaptive suspensions with force control, the drive and suspension system uses fast-response force-controlled actuators so it can control even high-speed impacts. More so, unlike the legs on force-controlled legged robots (e.g. quadrupeds or bipeds), the legs are mounted to a spinning wheel and do not need to stop and reverse direction with each “step,” allowing vehicles to achieve higher speeds.

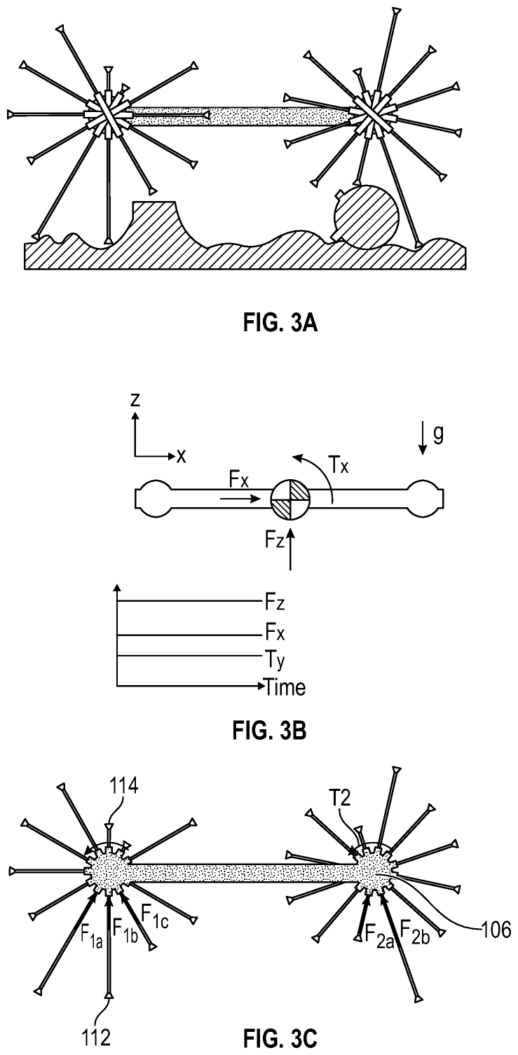

The drive and suspension system includes the ability to control the vehicle entirely using force/torque control techniques (instead of position or velocity control). Force control allows for an extremely smooth ride over unseen rough terrain. In fact, a rider could describe the ride experience as “floating.” This smooth ride is also what enables high speed locomotion on rough terrain, as rocks, bumps and potholes are simply not “felt” by the chassis, rendering high speeds safer. FIG. 3A depicts a set of rough and non-rigid terrain scenarios. As depicted in FIG. 3B, a set of overall chassis torques and forces (i.e., chassis wrench) can be arbitrarily chosen to suit desired ride characteristics regardless of the terrain. Notably, these desired forces can render flat, smooth, non-rotating, minimum-jerk chassis motion, which subjectively speaking, would feel to a rider like they are being transported without jostles or impacts. For each of thousands of calculation cycles per second, kinematic and dynamical algorithms compute the necessary wheel-motor torques and leg-actuator forces to achieve the desired chassis wrench, as illustrated in FIG. 3C.

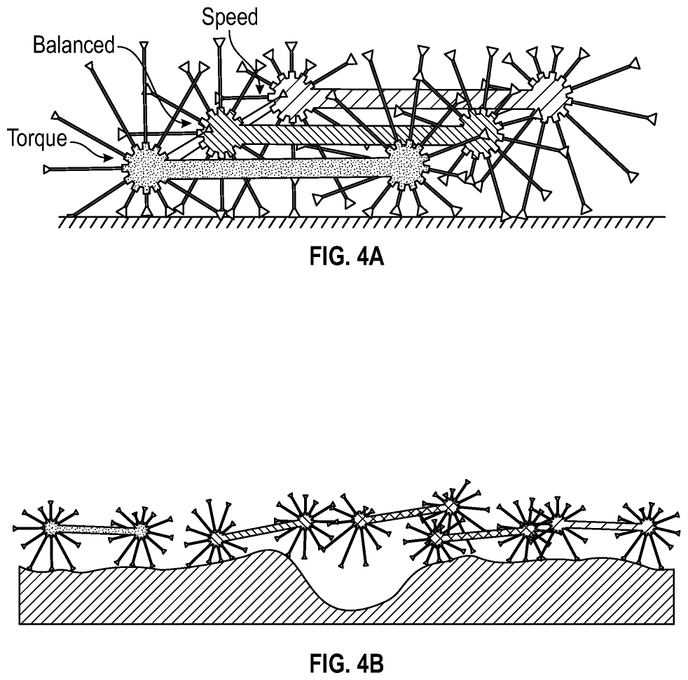

The drive and suspension system allows transport through rocky, hilly, or even mountainous terrain at higher speeds than previous ground vehicles. As depicted in FIG. 4A, to accelerate with maximum motor efficiency, the changing effective leg radius can continuous vary the effective transmission gearing from high torques to high speeds. Being a ground-based platform, the drive and suspension system is inherently more suited for carrying heavy payloads or traveling through forests or other environments with a restrictive canopy. Further, the force/torque-controllability allows for the execution of highly-dynamic maneuvers like jumping, as depicted in FIG. 4B.

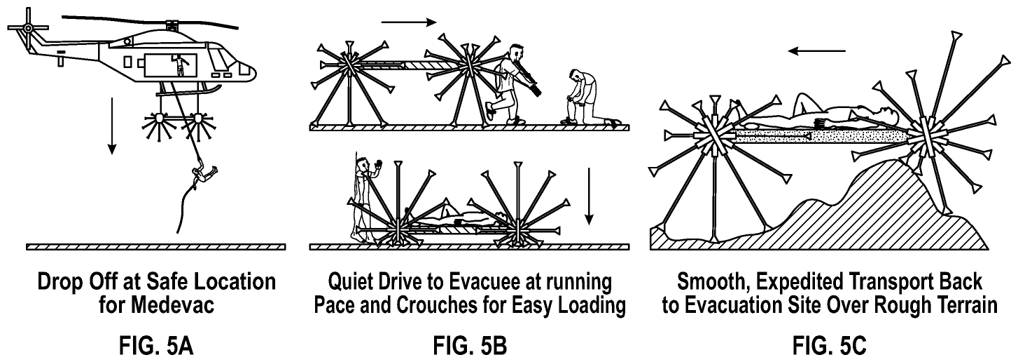

Possible applications of the drive and suspension system include in-field medical evacuations, or medevacs, which often require expeditious transport while ensuring patient safety from jerk and impacts. For this reason, patients requiring minimal disturbance (e.g., spinal cord injuries) are almost exclusively airlifted by helicopter. In scenarios where aerial approaches are denied, such as exposure to enemy fire, the drive and suspension system offers a ground-based alternative for safely and expeditiously evacuating injured personnel. This ground-based medevac scenario is visually depicted in FIGS. 5A-5C. In addition, the continuous paddling-like behavior can be adapted to a torque-controlled swimming device, to span across many terrain scenarios.

As used herein, a vehicle may include a scooter, motorcycle, car, truck, tank, or the like, or any combination or hybrid thereof. The vehicle may include an internal combustion engine (ICE), an electric motor, or a hybrid thereof. The vehicle may be manually and/or remotely driven or operated (e.g., no autonomy) and/or configured and/or programmed to operate in a fully autonomous (e.g., driverless) mode (e.g., Level-5 autonomy) or in one or more partial autonomy modes which may include driver assist technologies. Examples of partial autonomy (or driver assist) modes are widely understood in the art as autonomy Levels 1 through 4. A vehicle having a Level-0 autonomous automation may not include autonomous driving features. An autonomous vehicle (AV) having Level-1 autonomy may include a single automated driver assistance feature, such as steering or acceleration assistance. Adaptive cruise control is one such example of a Level-1 autonomous system that includes aspects of both acceleration and steering. Level-2 autonomy in vehicles may provide partial automation of steering and acceleration functionality, where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location remote from the vehicle but within a control zone extending up to several meters from the vehicle while it is in remote operation. Level-3 autonomy in a vehicle can provide conditional automation and control of driving features. For example, Level-3 vehicle autonomy typically includes “environmental detection” capabilities, where the vehicle can make informed decisions independently from a present driver, such as accelerating past a slow-moving vehicle, while the present driver remains ready to retake control of the vehicle if the system is unable to execute the task. Level-4 autonomous vehicles can operate independently from a human driver, but may still include human controls for override operation. Level-4 automation may also enable a self-driving mode to intervene responsive to a predefined conditional trigger, such as a road hazard or a system failure. Level-5 autonomy is associated with autonomous vehicle systems that require no human input for operation, and generally do not include human operational driving controls.

### Illustrative Embodiments

FIGS. 2A-2C depict a drive and suspension system 100 in accordance with one or more embodiments of the disclosure. The system 100 includes a chassis 102, a first hub 104, and a second hub 106. In some instances, the second hub 106 may be omitted.

The first hub 104 is rotatably attached to the chassis 102. For example, the first hub 104 may be attached to the chassis 102 by and rotate about an axle. In certain embodiments, a first rotary actuator is mechanically connected to the first hub 104 and is configured rotate the first hub 104. Any suitable rotary actuator or motor may be used. In some instance, the first hub 104 is mechanically connected to an ICE, an electric engine, or a combination thereof.

A plurality of first rods 108 are moveably attached to the first hub 104. Each first rod 108 is individually controllable. For example, each of the first rods 108 may be associated with a respective first linear actuator 110. Any suitable linear actuator or motor may be used. In this manner, the first linear actuator 110 may be configured to extend and retract the associated first rod 108 about the first hub 104.

In some instances, the first linear actuators 110 and the first rods 108 may form a piston-like device. That is, the first rods 108 may extend and retract within and/or about the first linear actuators 110. In other instances, the first rods 108 may be configured to translate linearly about and/or through the first hub 104 via the first linear actuator 110. For example, as depicted in FIG. 2B, each of the first rods 108 may include a first end 112 and a second end 114. The first end 112 is disposed on an opposite side of the first hub 104 as the second end 114. In this manner, when the first end 112 extends away from the first hub 104, the second end 114 retracts towards the first hub 104 and vice versa.

The second hub 106 is rotatably attached to the chassis 102. For example, the second hub 106 may be attached to the chassis 102 by and rotate about an axle. In certain embodiments, a second rotary actuator is mechanically connected to the second hub 106 and is configured rotate the second hub 106. Any suitable rotary actuator or motor may be used. In some instance, the second hub 106 is mechanically connected to an ICE, an electric engine, or a combination thereof.

A plurality of second rods 116 are moveably attached to the second hub 106. Each second rod 116 is individually controllable. For example, each of the second rods 116 may be associated with a respective second linear actuator 118. Any suitable linear actuator or motor may be used. In this manner, the second linear actuator 118 may be configured to extend and retract the associated second rod 116 about the second hub 106.

In some instances, the second linear actuators 118 and the second rods 116 may form a piston-like device. That is, the second rods 116 may extend and retract within and/or about the second linear actuators 118. In other instances, the second rods 116 may be configured to translate linearly about and/or through the second hub 106 via the second linear actuator 118. For example, each of the second rods 116 may include a first end 120 and a second end 122. The first end 120 is disposed on an opposite side of the second hub 106 as the second end 122. In this manner, when the first end 120 extends away from the second hub 106, the second end 122 retracts towards the second hub 106 and vice versa.

To provide the desired functionality described above, the first hub 104 and the second hub 106 are individually controllable. That is, the rotary actuator associated with each hub is configured to rotate the respective hub independent of the other hubs, if present. In addition, each of the rods associated with a particular hub are individually controllable such that each rod may be extended and retracted independent of the other rods. In this manner, the rods act as dynamic legs or spokes that are actively adjusted based on the terrain and the desired speed and ride characteristics.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A device comprising:
a chassis;
a first hub rotatably attached to the chassis;
a first rotary actuator mechanically connected to the first hub, wherein the first rotary actuator is configured rotate the first hub;
a plurality of first rods moveably attached to the first hub; and
a plurality of first linear actuators,
wherein each first rod of the plurality of first rods comprises a first linear actuator of the plurality of first linear actuators mechanically connected thereto, and wherein the first linear actuator is configured to extend and retract the first rod.

2. The device of claim 1, wherein each first rod of the plurality of first rods comprises a first end and a second end, wherein the first end is disposed on an opposite side of the first hub as the second end, and wherein when the first end extends away from the first hub, the second end retracts towards the first hub and vice versa.

3. The device of claim 2, wherein each first rod of the plurality of first rods is individually controllable.

4. The device of claim 1, wherein each first rod of the plurality of first rods is configured to translate linearly through the first hub.

5. The device of claim 1, further comprising
a second hub rotatably attached to the chassis;
a second rotary actuator mechanically connected to the second hub, wherein the second rotary actuator is configured rotate the second hub;
a plurality of second rods moveably attached to the second hub; and
a plurality of second linear actuators,
wherein each second rod of the plurality of second rods comprises a second linear actuator of the plurality of second linear actuators mechanically connected thereto, and wherein the second linear actuator is configured to extend and retract the second rod.

6. The device of claim 5, wherein each second rod of the plurality of second rods comprises a first end and a second end, wherein the first end is disposed on an opposite side of the second hub as the second end, and wherein when the first end extends away from the second hub, the second end retracts towards the second hub and vice versa.

7. The device of claim 6, wherein each second rod of the plurality of second rods is individually controllable.

8. The device of claim 5, wherein the first hub and the second hub are individually controllable.

9. The device of claim 5, wherein each second rod of the plurality of second rods is configured to translate linearly through the second hub.

10. A method comprising:
controlling a torque of a hub of a vehicle; and
controlling a force and length of at least one rod of a plurality of rods extending from the hub, wherein each of the plurality of rods are configured to extend and retract from the hub.

11. The method of claim 10, wherein each of the plurality of rods is individually controllable.

12. The method of claim 10, wherein each of the plurality of rods is configured to translate linearly through the hub.

13. A vehicle comprising:
a first rotatable hub having a plurality of first rods moveably attached thereto;
a plurality of first linear actuators configured to extend and retract the plurality of first rods;
a second rotatable hub having a plurality of second rods moveably attached thereto; and
a plurality of second linear actuators configured to extend and retract the plurality of second rods.

14. The vehicle of claim 13, wherein each first rod of the plurality of first rods comprises a first end and a second end, wherein the first end is disposed on an opposite side of the first rotatable hub as the second end, and wherein when the first end extends away from the first rotatable hub, the second end retracts towards the first rotatable hub and vice versa.

15. The vehicle of claim 14, wherein each first rod of the plurality of first rods is individually controllable.

16. The vehicle of claim 13, wherein each first rod of the plurality of first rods is configured to translate linearly through the first rotatable hub.

17. The vehicle of claim 13, wherein each second rod of the plurality of second rods comprises a first end and a second end, wherein the first end is disposed on an opposite side of the second rotatable hub as the second end, and wherein when the first end extends away from the second rotatable hub, the second end retracts towards the second rotatable hub and vice versa.

18. The vehicle of claim 17, wherein each second rod of the plurality of second rods is individually controllable.

19. The vehicle of claim 13, wherein the first rotatable hub and the second rotatable hub are individually controllable.

20. The vehicle of claim 13, wherein each second rod of the plurality of second rods is configured to translate linearly through the second rotatable hub.
